(19) United States
(12) Patent Application Publication
(10) Pub. No.: US 2013/0300283 A1
(43) Pub. Date: Nov. 14, 2013

(54) FLAT PANEL DISPLAY AND METHOD OF MANUFACTURING THE SAME

(71) Applicants: Jung-Jun Im, Yongin-city (KR); Oh-Seob Kwon, Yongin-city (KR); Byung-Uk Han, Yongin-city (KR); Sung-Soo Koh, Yongin-city (KR); Jae-Sang Ro, Yongin-city (KR); Won-Eui Hong, Yongin-city (KR); Seog-Young Lee, Yongin-city (KR)

(72) Inventors: Jung-Jun Im, Yongin-city (KR); Oh-Seob Kwon, Yongin-city (KR); Byung-Uk Han, Yongin-city (KR); Sung-Soo Koh, Yongin-city (KR); Jae-Sang Ro, Yongin-city (KR); Won-Eui Hong, Yongin-city (KR); Seog-Young Lee, Yongin-city (KR)

(21) Appl. No.: 13/942,477

(22) Filed: Jul. 15, 2013

Related U.S. Application Data
(63) Continuation of application No. 13/243,946, filed on Sep. 23, 2011.

(30) Foreign Application Priority Data
Sep. 28, 2010 (KR) 10-2010-0093800

(51) Int. Cl. H01J 5/20; H05B 33/10; H05B 33/04

(52) U.S. Cl. CPC H01J 5/20; H05B 33/04; H05B 33/10
USPC 313/504; 313/317; 445/25

(57) ABSTRACT

Flat panel displays and methods of manufacturing the displays are disclosed. In one embodiment, the flat panel display includes: i) a substrate, ii) a display unit formed over the substrate, iii) an encapsulation substrate formed so as to face the display unit and iv) a sealing member formed between the substrate and the encapsulation substrate so as to substantially surround the display unit. The display may further include i) a wiring unit formed between the substrate and the encapsulation substrate so as to substantially overlap with the sealing member, wherein the wiring unit includes at least one via hole and ii) an inlet unit connected to the wiring unit and connectable to an external power source.

### CROSS-REFERENCE TO RELATED PATENT APPLICATION

This application is a continuation application which claims priority under 35 U.S.C. §120 from application Ser. No. 13/243,946 filed Sep. 23, 2011, which is hereby incorporated by reference. application Ser. No. 13/243,946 claimed the benefit of Korean Patent Application No. 10-2010-0093800, filed on Sep. 28, 2010, in the Korean Intellectual Property Office, the disclosure of which is incorporated herein in its entirety by reference.

### BACKGROUND

1. Field

The described technology generally relates to flat panel displays and methods of manufacturing the same, and more particularly, to flat panel displays with improved encapsulation characteristics, and methods of manufacturing the displays.

2. Description of the Related Technology

Recently, display apparatuses have been replaced with portable, thin flat panel displays. Flat panel displays such as organic light-emitting displays and liquid crystal displays provide excellent image quality.

A flat panel display generally includes a display unit formed on a substrate, and an encapsulation substrate formed on the display unit to protect the display unit. Also, a sealing member is disposed between the substrate and the encapsulation substrate. Thus, the display unit disposed between the substrate and the encapsulation substrate is protected from the environment.

The sealing member may be formed using any of various methods; for example, a material for forming a sealing member is disposed between a substrate and an encapsulation substrate and then melted and hardened using heat. Thus, the substrate and the encapsulation substrate are coupled to each other in the above-described operation.

### SUMMARY

One inventive aspect is a flat panel display and method of manufacturing the same, in which encapsulation characteristics are improved.

Another aspect is a flat panel display comprising: a substrate; a display unit disposed on the substrate; an encapsulation substrate disposed to face the display unit; a sealing member disposed between the substrate and the encapsulation substrate to surround the display unit; a wiring unit that is disposed between the substrate and the encapsulation substrate to overlap the sealing member and that includes at least one via hole; and an inlet unit that is connected to the wiring unit to apply a voltage to the wiring unit and that is to be connectable to an external power source.

The sealing member may contact the substrate via the via hole. The wiring unit may be formed on the substrate, and the sealing member may be disposed between the wiring unit and the encapsulation substrate.

The sealing member may be disposed to fill the via hole. The sealing member may contact the encapsulation substrate. The sealing member may contain a frit. The display unit may comprise an organic light emitting device.

Another aspect is a method of manufacturing a flat panel display, the method comprising: providing a substrate on which a display unit is disposed; disposing an encapsulation substrate to face the display unit; forming a sealing member surrounding the display unit, between the substrate and the encapsulation substrate; forming a wiring unit between the substrate and the encapsulation substrate, wherein the wiring unit is disposed to overlap the sealing member and includes at least one via hole; and forming an inlet unit that is connected to the wiring unit to apply a voltage to the wiring unit and that is formed to be connectable to an external power source, wherein the forming of the sealing member comprises disposing a material for forming the sealing member between the substrate and the encapsulation substrate; electrically connecting the power source to the inlet unit; and melting and hardening the material for forming the sealing member by using heat generated in the wiring unit when applying a voltage to the wiring unit through the power source.

The sealing member may contain a frit.

Another aspect is a flat panel display comprising: a substrate; a display unit formed over the substrate; an encapsulation substrate formed so as to face the display unit; a sealing member formed between the substrate and the encapsulation substrate so as to substantially surround the display unit; a wiring unit formed between the substrate and the encapsulation substrate so as to substantially overlap with the sealing member, wherein the wiring unit includes at least one via hole; and an inlet unit connected to the wiring unit and connectable to an external power source.

In the above display, the sealing member contacts the substrate through the via hole. In the above display, the wiring unit is formed on the substrate, and wherein the sealing member is formed between the wiring unit and the encapsulation substrate. In the above display, the sealing member substantially fills the via hole. In the above display, the sealing member contacts the encapsulation substrate. In the above display, the sealing member contains a frit. In the above display, the display unit comprises an organic light emitting device.

Another aspect is a method of manufacturing a flat panel display, the method comprising: providing a substrate, wherein a display unit is formed over the substrate; providing an encapsulation substrate which faces the display unit; forming a sealing member substantially surrounding the display unit, between the substrate and the encapsulation substrate; forming a wiring unit between the substrate and the encapsulation substrate, wherein the wiring unit at least partially overlaps with the sealing member and includes at least one via hole; and forming an inlet unit connected to the wiring unit to apply a voltage to the wiring unit and connectable to an external power source.

In the above method, the sealing member contains a frit. In the above method, the forming of the sealing member comprises: providing a sealing material between the substrate and the encapsulation substrate; electrically connecting the external power source to the inlet unit; generating thermal energy in the wiring unit based on electrical energy provided from the external power source; and melting and hardening the sealing material with the generated thermal energy. In the above method, the sealing member contacts the substrate through the via hole. In the above method, the sealing member substantially fills the via hole.

Another aspect is a flat panel display comprising: a substrate; a display unit formed over the substrate; an encapsulation substrate formed so as to face the display unit; a sealing member formed between the substrate and the encapsulation substrate so as to substantially surround the display unit; and a wiring unit formed within the sealing member and configured to generate thermal energy based on electrical energy provided from a power source, wherein a plurality of via holes are present in the wiring unit.

The above display further comprises an inlet unit connected to the wiring unit and connectable to the power source, wherein the power source is an internal power source or an external power source. In the above display, the external power source is a voltage source, and wherein the inlet unit comprises first and second sub-inlet units which are spaced apart and are configured to conduct current therethrough provided from the voltage source.

In the above display, the width of the sealing member is substantially the same with that of the wiring unit. In the above display, the sealing member at least partially fills one or more of the via holes. In the above display, the sealing member contacts the substrate through one or more of the via holes. In the above display, the wiring unit contacts the substrate but does not contact the encapsulation substrate. In the above display, at least some of the via holes are substantially evenly distributed.

### BRIEF DESCRIPTION OF THE DRAWINGS

FIG. 1 is a plan view illustrating a flat panel display according to an embodiment.

FIG. 2 is an expanded view of a portion A of the flat panel display of FIG. 1.

FIG. 3 is a cross-sectional view illustrating the flat panel display cut along a line of FIG. 1.

FIG. 4 is an expanded view of a portion X of FIG. 3.

FIG. 5 is a plan view illustrating a method of applying power to form a sealing member, when manufacturing the flat panel display of FIG. 1, according to an embodiment.

### DETAILED DESCRIPTION

The quality of a flat panel display is generally influenced by characteristics of the display unit which are likely to be deteriorated by water, gas, or other foreign substances. In particular, it is difficult to form a sealing member between a substrate and an encapsulation substrate and thus it is difficult to efficiently encapsulate a display unit.

Embodiments will now be described more fully with reference to the accompanying drawings.

Referring to FIG. 1, a flat panel display 100 is shown. In FIG. 1, an encapsulation substrate 102 is not illustrated for convenience of description.

Referring to FIGS. 1 through 4, the flat panel display 100 includes a substrate 101, a display unit 110, the encapsulation substrate 102, a wiring unit 150, and an inlet unit 180, and the wiring unit 150 includes at least one via hole 151.

The substrate 101 may be formed of a transparent glass material that includes SiO₂ as a main component. However, the substrate 101 is not limited thereto, and may be formed of a transparent plastic material. The plastic material may also be an organic material selected from the group consisting of polyethersulphone (PES), polyacrylate (PAR), polyetherimide (PEI), polyethyelenen napthalate (PEN), polyethyeleneterepthalate (PET), polyphenylene sulfide (PPS), polyallylate, polyimide, polycarbonate (PC), cellulose triacetate (TAC), and cellulose acetate propionate (CAP), which are insulating organic materials.

The display unit 110 is disposed on the substrate 101. The display unit 110 may have any of various forms. The display unit 110 according to the current embodiment includes an organic light-emitting device 120, but is not limited thereto; alternatively, the display unit 110 may include a liquid crystal device. The display unit 110 will be described in detail later.

The encapsulation substrate 102 is disposed to face the display unit 110. A sealing member (or sealing material) 170 is disposed between the substrate 101 and the encapsulation substrate 102. The sealing member 170 is formed to substantially surround the display unit 110. The sealing member 170 facilitates coupling between the substrate 101 and the encapsulation substrate 102. The sealing member 170 may contain a fit.

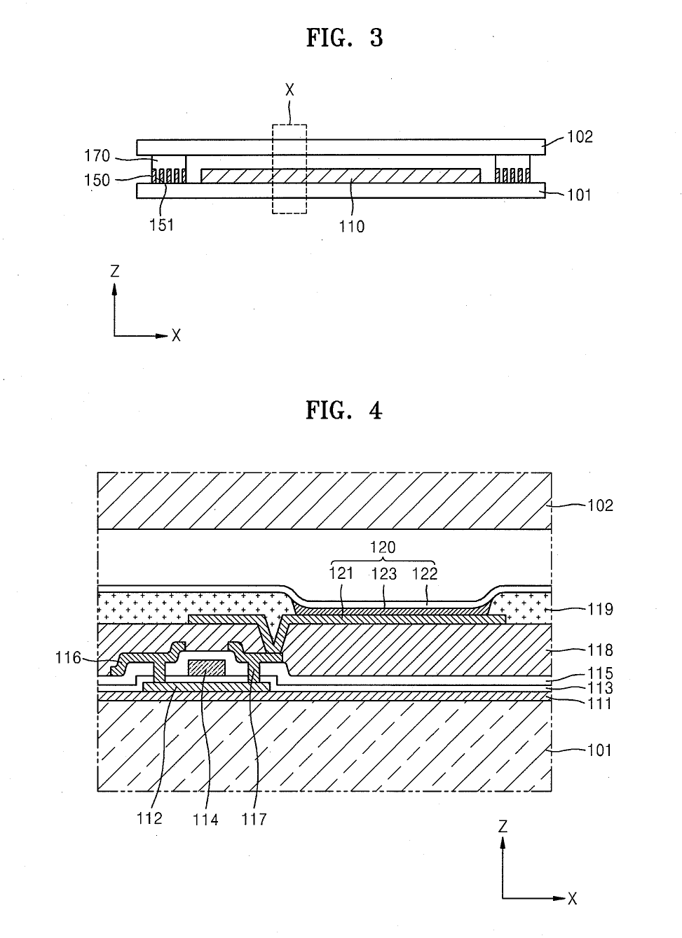

The wiring unit 150 is formed to substantially overlap with the sealing member 170. Thus, the wiring unit 150 is formed to substantially surround the display unit 110. The wiring unit 150 may be formed using any of various conductive materials. In one embodiment, the wiring unit 150 contacts the substrate 101 but does not contact the encapsulation substrate 102 as shown in FIG. 3.

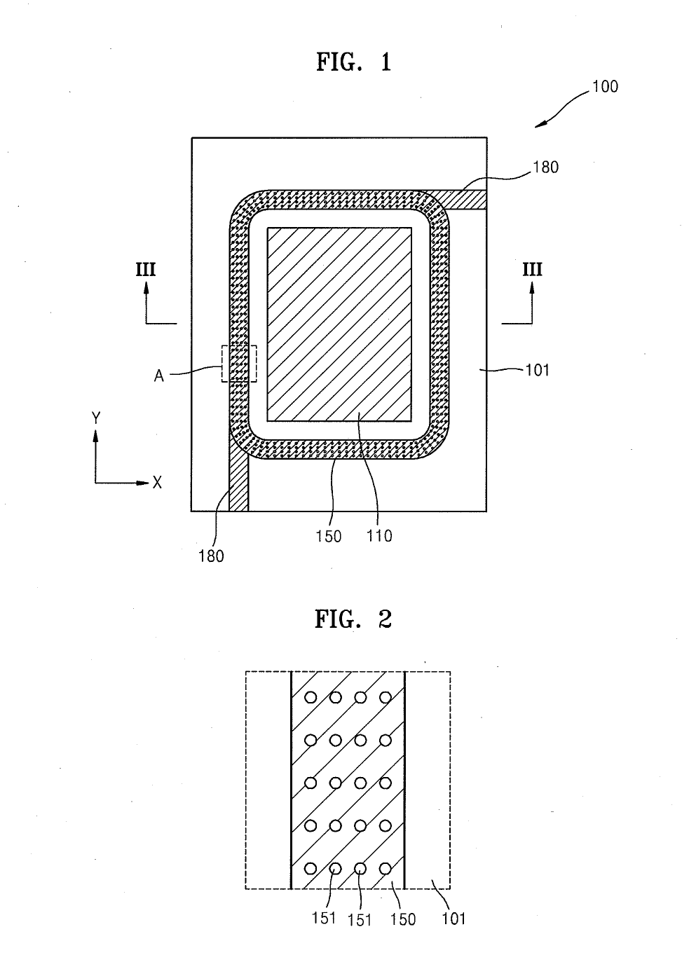

The wiring unit 150 includes the at least one via hole 151. In one embodiment, the at least one via hole 151 comprises a plurality of holes at least some of which are substantially evenly distributed as shown in FIG. 2. The sealing member 170 may contact the substrate 101 through the via hole 151. The sealing member 170 may be formed to substantially fill the via hole 151, but is not limited thereto. As long as the sealing member 170 is formed inside the via hole 151, the sealing member 170 may contact the substrate 101 even when the via hole 151 is not completely filled with the sealing member 170. That is, the sealing member 170 may at least partially fill the hole 151.

When the via hole 151 is substantially completely filled with the sealing member 170, the adhesion between the sealing member 170, the wiring unit 150, and the substrate 101 may be enhanced.

The wiring unit 150 is formed on the substrate 101, the sealing member 170 is formed on the wiring unit 150, and the encapsulation substrate 102 is disposed on the sealing member 170. Since the sealing member 170 is formed in the via hole 151 of the wiring unit 150, the sealing member 170 may contact the substrate 101. The sealing member 170 also contacts the encapsulation substrate 102.

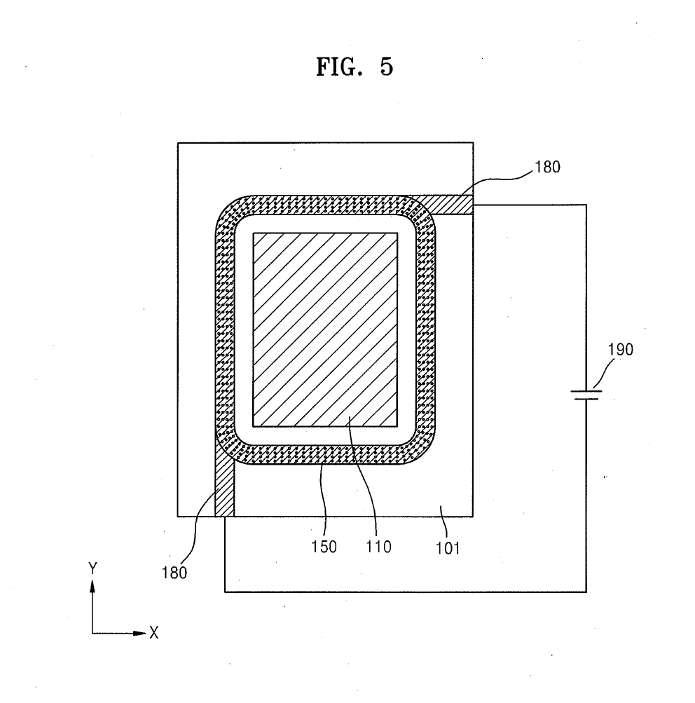

In one embodiment, as shown in FIG. 1, the inlet unit 180 includes first and second sub-inlet units which are connected to the wiring unit 150 and connectable to an external power source (See FIG. 5). The inlet unit 180 is formed at an end of the wiring unit 150. The inlet unit 180 is formed to be easily electrically connected to an external power source (not shown).

In one embodiment, the sealing member 170 is formed by disposing a sealing material between the substrate 101 and the encapsulation substrate 102 and by melting and hardening the material. While performing the operation of forming the sealing member 170, the external power source may be connected to the inlet unit 180 to apply a voltage to the wiring unit 150 via the inlet unit 180, thereby generating thermal energy such as joule heat in the wiring unit 150. By using this heat, the material for forming the sealing member 170 may be melted and then hardened. The inlet unit 180 may be formed using the same material as that of the wiring unit 150.

The display unit 110 may have any of various forms, and according to the current embodiment, an organic light-emitting device may be applied as the display unit 110. Hereinafter, the display unit 110 will be described in detail with reference to FIG. 4.

A buffer layer 111 is formed on the substrate 101. The buffer layer 111 may provide a planar surface on the substrate 101 and prevents water or foreign substances from penetrating into the substrate 101.

An active layer 112 having a predetermined pattern is formed on the buffer layer 111. The active layer 112 may be formed using an inorganic semiconductor such as an amorphous silicon or polysilicon, or an organic semiconductor, and includes a source region, a drain region, and a channel region.

The source and drain regions may be formed by doping the active layer 112 formed at least partially of an amorphous silicon or polysilicon, with impurities. When the active layer 112 is doped with a Group III element such as boron (B), a p-type semiconductor may be formed, and when the active layer 112 is doped with a Group V element such as nitrogen (N), an n-type semiconductor may be formed.

A gate insulation layer 113 is formed on the active layer 112, and a gate electrode 114 is formed on a predetermined region of the gate insulation layer 113. The gate insulation layer 113 is formed to insulate the active layer 112 from the gate electrode 114 and may be formed of an organic material or an inorganic material such as SiNₓ or SiO₂.

The gate electrode 114 may be formed at least partially of a metal such as Ag, Cu, Ni, Pt, Pd, Al, or Mo, or a metal alloy such as Al:Nd or Mo: W, but is not limited thereto and may be formed using any of various materials in consideration of adhesion properties, flatness, electric resistance, and processablity. The gate electrode 114 is electrically connected to a gate line (not shown) through which an electrical signal is applied.

An interlayer insulation layer 115 is formed over the gate electrode 114. The interlayer insulation layer 115 and the gate insulation layer 113 are formed so as to expose the source region and the drain region of the active layer 112, and a source electrode 116 and a drain electrode 117 are formed to contact the exposed portions of the active layer 112.

The source electrode 116 and the drain electrode 117 may be formed at least partially of a metal such as Au, Pd, Pt, Ni, Rh, Ru, Ir, or Os, or an alloy formed of at least two metals, such as an Al alloy, an Mo alloy, an Al:Nd alloy, or an MoW alloy, but are not limited thereto.

In one embodiment, a passivation layer 118 is formed to cover the source electrode 116 and the drain electrode 117. The passivation layer 118 may be formed at least partially of an inorganic insulation layer and/or an organic insulation layer. The inorganic insulation layer may include SiO₂, SiNₓ, SiON, Al₂O₃, TiO₂, Ta₂O₅, HfO₂, ZrO₂, BST, or PZT, and the organic insulation layer may include a widely used polymer (e.g., polymethylmethacrylate (PMMA) or polystyrene (PS)), a polymer derivative having a phenol group, an acrylic polymer, an imide based polymer, an arylether based polymer, an amide based polymer, a fluorine based polymer, a p-xylene based polymer, a vinyl alcohol based polymer, or a blend of these. The passivation layer 118 may be formed at least partially of a complex laminate formed using an inorganic insulation layer and an organic insulation layer.

In one embodiment, the passivation layer 118 is formed to expose a portion of the drain electrode 117, and the organic light emitting device 120 is formed so as to be electrically connected to the exposed portion of the drain electrode 117. The organic light-emitting device 120 includes a first electrode 121, a second electrode 122, and an intermediate layer 123. In one embodiment, the first electrode 121 and the drain electrode 117 contact each other. In another embodiment, the first electrode 121 and the source electrode 116 contact each other.

The intermediate layer 123 includes an organic emissive layer, and when a voltage is applied via the first electrode 121 and the second electrode 122, visible light is generated.

A pixel define layer 119 is formed using, for example, an insulating material on the first electrode 121. A predetermined opening is formed in the pixel define layer 119 so as to expose a portion of the first electrode 121. The intermediate layer 123 is formed on the exposed portion of the first electrode 121. In addition, the second electrode 122 is formed so as to be electrically connected to the intermediate layer 123.

The first electrode 121 and the second electrode 122 have polarities of an anode electrode and a cathode electrode, respectively. The polarities of the first electrode 121 and the second electrode 122 may be interchanged.

The encapsulation substrate 102 is disposed on the second electrode 122.

The wiring unit 150 of the flat panel display 100 includes the via hole 151. The sealing member 170 is disposed in the via hole 151 in order for the sealing member 170 to contact the substrate 101. Accordingly, the adhesion between the sealing member 170 and the substrate 101 is enhanced. Also, by increasing the contact surface area between the sealing member 170 and the wiring unit 150, the adhesion between the sealing member 170 and the wiring unit 150 is enhanced.

The sealing member 170 also contacts the encapsulation substrate 102.

As a result, the adhesion between the substrate 101 and the encapsulation substrate 102 is enhanced and encapsulation characteristics of the flat panel display 100 are improved.

FIG. 5 is a plan view illustrating an operation of applying power to form the sealing member 170, when manufacturing the flat panel display 100 of FIG. 1, according to an embodiment.

The flat panel display 100 of FIG. 1 is formed by using several operations, and among these operations, the operation of forming the sealing member 170 includes disposing a material for forming the sealing member 170, sintering and drying the material, and then melting and hardening the same.

In the melting operation, two ends of a power source 190 are connected to the inlet unit 180. When a voltage is applied from the power source 190 to the inlet unit 180, joule heat is generated in the wiring unit 150. Accordingly, the material of the sealing member 170 disposed to overlap the wiring unit 150 is easily melted and then hardened, and thus the sealing member 170 is formed. The sealing member 170 facilitates coupling between the substrate 101 and the encapsulation substrate 102. The wiring unit 150 of the flat panel display 100 includes the via hole 151. The sealing member 170 is disposed so as to contact the substrate 101 through the via hole 151, thereby improving coupling characteristics between the sealing member 170 and the substrate 101. Also, coupling characteristics between the sealing member 170 and the wiring unit 150 are improved.

In addition, when thermal energy such as joule heat is generated in the wiring unit 150, the heat is efficiently transferred to the material for forming the sealing member 170, thus facilitating forming of the sealing member 170. Thus, the adhesion between the substrate 101 and the encapsulation substrate 102 is enhanced and the encapsulation characteristics of the flat panel display 100 are improved.

According to at least one of the disclosed embodiments, since the sealing material is melted and hardened based on thermal energy generated in the wiring unit, encapsulation characteristics may be easily improved.

While the disclosed embodiments have been particularly shown and described with reference to the accompanying drawings, it will be understood by those of ordinary skill in the art that various changes in form and details may be made therein without departing from the spirit and scope of tthe following claims.

What is claimed is:

1. A flat panel display comprising:
a substrate;
a display unit formed over the substrate;
an encapsulation substrate formed so as to face the display unit;
a sealing member formed between the substrate and the encapsulation substrate so as to substantially surround the display unit;
a single wiring unit formed between the substrate and the encapsulation substrate so as to substantially overlap with the sealing member, wherein the wiring unit includes at least one via hole, wherein the at least one via hole passes through the single wiring unit, and wherein the wiring unit surrounds the four sides of the display unit; and
an inlet unit connected to the wiring unit and connectable to an external power source.

2. The flat panel display of claim 1, wherein the sealing member contacts the substrate through the via hole.

3. The flat panel display of claim 1, wherein the wiring unit is formed on the substrate, and wherein the sealing member is formed between the wiring unit and the encapsulation substrate.

4. The flat panel display of claim 1, wherein the sealing member substantially fills the via hole.

5. The flat panel display of claim 1, wherein the sealing member contacts the encapsulation substrate.

6. The flat panel display of claim 1, wherein the sealing member contains a frit.

7. The flat panel display of claim 1, wherein the display unit comprises an organic light emitting device.

8. A method of manufacturing a flat panel display, the method comprising:
providing a substrate, wherein a display unit is formed over the substrate;
providing an encapsulation substrate which faces the display unit;
forming a sealing member substantially surrounding the display unit, between the substrate and the encapsulation substrate;
forming a wiring unit between the substrate and the encapsulation substrate, wherein the wiring unit at least partially overlaps with the sealing member and includes at least one via hole; and
forming an inlet unit connected to the wiring unit to apply a voltage to the wiring unit and connectable to an external power source.

9. The method of claim 8, wherein the sealing member contains a frit.

10. The method of claim 8, wherein the forming of the sealing member comprises:
providing a sealing material between the substrate and the encapsulation substrate;
electrically connecting the external power source to the inlet unit;
generating thermal energy in the wiring unit based on electrical energy provided from the external power source; and
melting and hardening the sealing material with the generated thermal energy.

11. The method of claim 8, wherein the sealing member contacts the substrate through the via hole.

12. The method of claim 8, wherein the sealing member substantially fills the via hole.

13. A flat panel display comprising:
a substrate;
a display unit formed over the substrate;
an encapsulation substrate formed so as to face the display unit;
a sealing member formed between the substrate and the encapsulation substrate so as to substantially surround the display unit; and
a single wiring unit formed within the sealing member and configured to generate thermal energy based on electrical energy provided from a power source, wherein a plurality of via holes are present in the wiring unit, wherein the via holes pass through the single wiring unit, and wherein the wiring unit surrounds the four sides of the display unit.

14. The flat panel display of claim 13, further comprising an inlet unit connected to the wiring unit and connectable to the power source, wherein the power source is an internal power source or an external power source.

15. The flat panel display of claim 14, wherein the external power source is a voltage source, and wherein the inlet unit comprises first and second sub-inlet units which are spaced apart and are configured to conduct current therethrough provided from the voltage source.

16. The flat panel display of claim 13, wherein the sealing member at least partially fills one or more of the via holes.

17. The flat panel display of claim 13, wherein the sealing member contacts the substrate through one or more of the via holes.

18. The flat panel display of claim 13, wherein at least some of the via holes are substantially evenly distributed.

19. The flat panel display of claim 1, wherein the wiring unit includes a plurality of via holes.
